(19) United States
(12) Patent Application Publication
(10) Pub. No.: US 2009/0316551 A1
(43) Pub. Date: Dec. 24, 2009

(54) APPARATUS AND METHOD FOR WRITING DATA INTO STORAGE MEDIUM

(76) Inventors: Hang-Kaung Shu, Taipei City (TW); Shih-Hsin Chen, Hsinchu County (TW); Jin-Bin Yang, Changhua County (TW); Ping-Sheng Chen, Chiayi County (TW)

Correspondence Address: NORTH AMERICA INTELLECTUAL PROPERTY CORPORATION, P.O. BOX 506, MERRIFIELD, VA, 22116, US

(21) Appl. No.: 12/405,253

(22) Filed: Mar. 17, 2009

Related U.S. Application Data
(60) Provisional application No. 61/073,786, filed on Jun. 19, 2008.

(51) Int. Cl. G11B 20/18

(52) U.S. Cl. 369/53.31; G9B/20.046

(57) ABSTRACT

An apparatus for writing encoded data into a storage medium includes a quality-check signal generator, a defect judgment unit and a verification unit. The quality-check signal generator is utilized for generating a quality-check signal; the defect judgment unit is coupled to the quality-check signal generator and is utilized for generating a defect judgment result according to the quality-check signal; and the verification unit is coupled to the defect judgment unit and is utilized for referring to the defect judgment result to selectively verify the encoded data that have been written into the storage medium.

### CROSS REFERENCE TO RELATED APPLICATIONS

This application claims the priority of U.S. Provisional Application No. 61/073,786, filed Jun. 19, 2008, which is included herein by reference.

### BACKGROUND OF THE INVENTION

The present invention relates to an apparatus for writing data into a storage medium, and more particularly, to an apparatus having a verification unit that selectively verifies the data that have been written into the storage medium.

During a process in which data blocks are encoded and written into a storage medium such as an optical disc, when it is at a specific time or at a time when one data block is written into the storage medium, verification is used to check an accuracy of the data that have been written into the storage medium. When the verification is performed, the encoding processing is stopped. Because all the data written into the storage medium needs to be verified no matter what the quality of the data have been written into the storage medium, therefore, time is wasted when the accurate data are verified.

### SUMMARY OF THE INVENTION

It is therefore an objective of the present invention to provide an apparatus having a verification unit that selectively verifies the data that have been written into the storage medium and related method, to solve the above-mentioned problems.

According to one embodiment of the present invention, an apparatus for writing encoded data into a storage medium includes a quality-check signal generator, a defect judgment unit and a verification unit. The quality-check signal generator is utilized for generating a quality-check signal; the defect judgment unit is coupled to the quality-check signal generator and is utilized for generating a defect judgment result according to the quality-check signal; and the verification unit is coupled to the defect judgment unit and is utilized for referring to the defect judgment result to selectively verify the encoded data that have been written into the storage medium.

According to another embodiment of the present invention, a method for writing encoded data into a storage medium includes: generating a quality-check signal; generating a defect judgment result according to the quality-check signal; and referring to the defect judgment result to selectively verify the encoded data that have been written into the storage medium.

According to the apparatus and the method of the present invention, a verification unit is utilized for referring to the defect judgment result to selectively verify the encoded data that have been written into the storage medium. Therefore, not all the data that have been written into the storage medium need to be verified, and encoding and writing process are more efficient.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an apparatus for encoding a data block to generate the encoded data and writing the encoded data into a storage medium according to one embodiment of the present invention.

FIG. 2 is a diagram illustrating a block diagram according a first embodiment of the defect judgment unit shown in FIG. 1.

FIG. 3 is a diagram illustrating an interleaved data block.

FIG. 4 is a diagram illustrating a de-interleaved data block related to the interleaved data block shown in FIG. 3.

FIG. 5 is a diagram illustrating a block diagram according a second embodiment of the defect judgment unit shown in FIG. 1.

FIG. 6 is a diagram illustrating a block diagram according to a third embodiment of the defect judgment unit shown in FIG. 1.

FIG. 7 is a simplified flowchart of writing encoded data into a storage medium according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

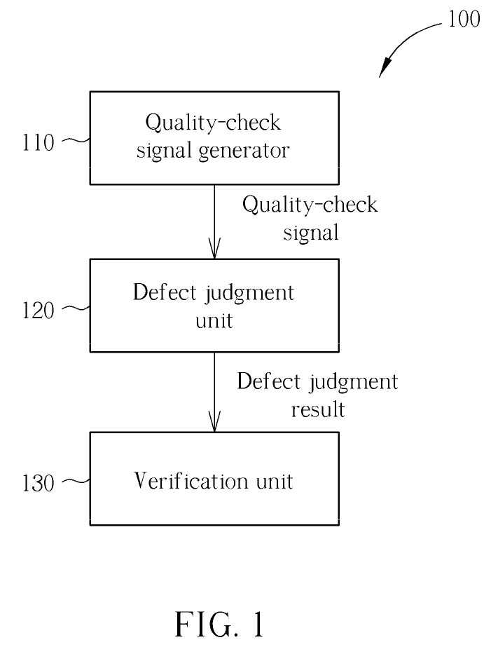

Please refer to FIG. 1. FIG. 1 is a diagram illustrating an apparatus 100 for encoding a data block to generate the encoded data and writing the encoded data into a storage medium according to one embodiment of the present invention. As shown in FIG. 1, the apparatus 100 includes a quality-check signal generator 110, a defect judgment unit 120 and a verification unit 130. The quality-check signal generator 110 is utilized for generating a quality-check signal; the defect judgment unit 120 is coupled to the quality-check signal generator 110 and is utilized for generating a defect judgment result according to the quality-check signal; and the verification unit 130 is coupled to the defectjudgment unit 120 and is utilized for referring to the defect judgment result to selectively verify the encoded data that have been written into the storage medium. It means that the verification unit 130 may need to verify the data written in the storage medium only when the defect judgment result indicates the data written in the storage medium probably has a risk of decoding error. Therefore, the verification process will be executed more efficiently rather than verifying all the data written in the storage medium without considering the probability of risk of decoding error.

Moreover, in some other embodiments, the defect judgment result can be used to decide whether the data written into the storage medium should be stopped. When the defect judgment result indicates that there are too many errors in the data, data writing process will stop. The related description is known by the persons skilled in the art, and is omitted for simplicity.

Taking an optical disc as an example of the storage medium, the quality-check signal generated from the quality-check signal generator 110 provides information indicating which area of the optical disc is possibly a decoding error occurs. The information of the quality-check signal can be generated according to an intensity of light reflected from the optical disc, a reflection ratio of the optical disc, or other information about the quality of the optical disc. In addition, the information of the quality-check signal can also be generated according to a focus error signal, a tracking error signal or other servo control signals.

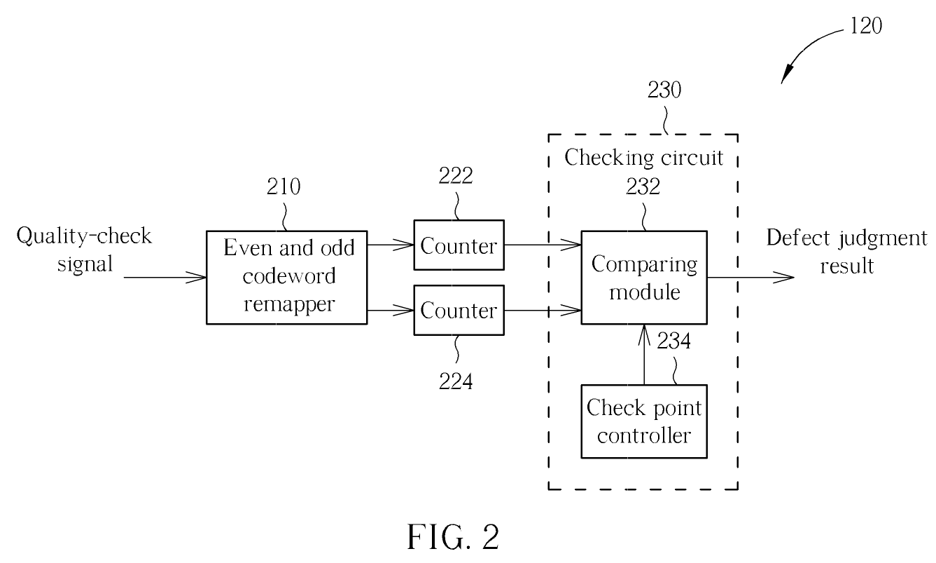

Please refer to FIG. 2. FIG. 2 is a diagram illustrating a block diagram according to a first embodiment of the defectjudgment unit 120 shown in FIG. 1. As shown in FIG. 2, the defect judgment unit 120 includes an even and odd codeword remapper 210, two counters 222 and 224, and a checking circuit 230, where the checking circuit 230 includes a comparing module 232 and a check point controller 234. The detailed operations of the defect judgment unit 120 shown in FIG. 2 are described as follows by taking a blu-ray disc as an example of the storage medium.

When writing an original data block into the blu-ray disc, the original data block has an interleaving operation performed and becomes an interleaved data block first. Then, the interleaved data block is encoded and written into the blu-ray disc. The definitions of a size of the original data block and the interleaved data block and the interleaving operations are described in a specification of the blu-ray disc, and as a person skilled in this art should understand this interleaving operation, further descriptions are therefore omitted here.

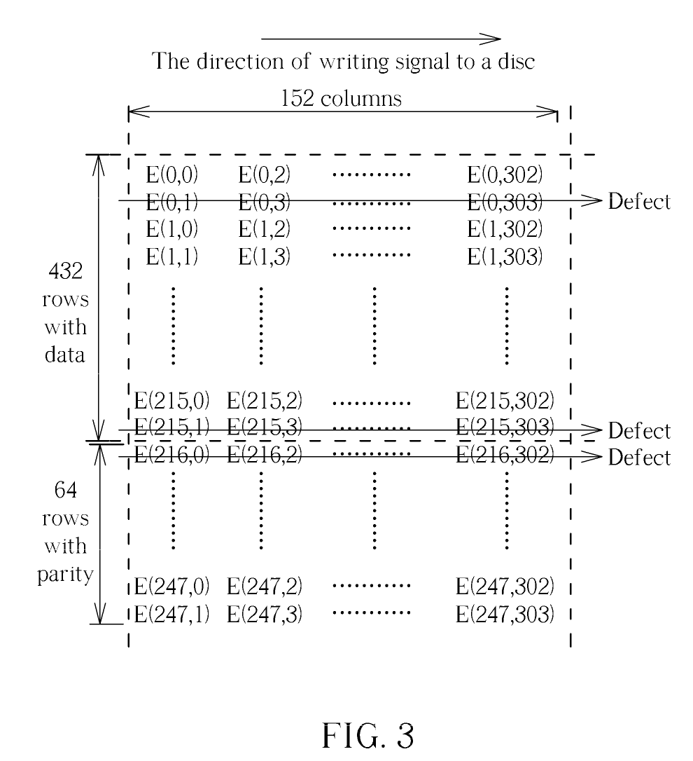

FIG. 3 is a diagram illustrating an interleaved data block. As shown in FIG. 3, the interleaved data block includes 152 columns and each column includes 432 main data and 64 parity data, where each data E(X, Y) shown in FIG. 3 is a byte. The data of the interleaved data block are sequentially written into the blu-ray disc from left to right and line by line, that is, E(0,0), E(0,2), . . . , E(0,302), E(0,1), E(0,3), . . . , E(0,303), . . . , E(247,1), E(247,3), . . . , E(247,303). In addition, the quality-check signal, which is generated by quality-check signal generator, indicates the current data such as the recording data with a possible decoding error. In this embodiment, three lines of data with ‘Defect’ labels are possible to induce the decoding errors.

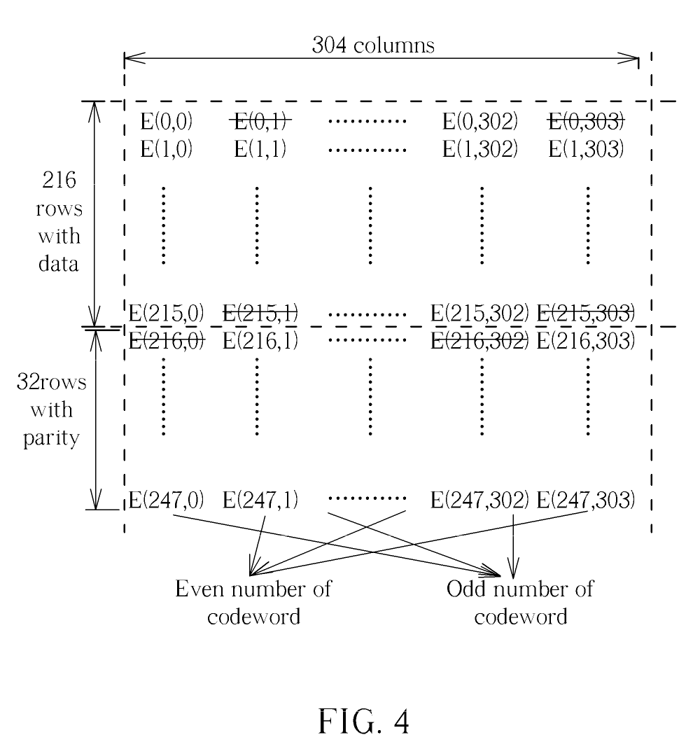

When the data that have been written on the blu-ray disc need to be read out and decoded, the interleaved data block needs to have a de-interleaving operation performed and becomes a de-interleaved data block (i.e., the original data block). Please refer to FIG. 4. FIG. 4 is a diagram illustrating a de-interleaved data block related to the interleaved data block shown in FIG. 3. As shown in FIG. 4, after performing the de-interleaving operation upon the interleaved data block in this embodiment, the codewords are divided into two codeword groups, even codeword group (such as E(0, 1), E(1, 1) . . . E(247, 1), and E(0, 303), E(1, 303) . . . E(247, 303) in FIG. 4) and odd codeword group (such as E(0, 0), E(1, 0) . . . E(247, 0), and E(0, 302), E(1, 302) . . . E(247, 302) in FIG. 4). There are three ‘Defect’ labels cross the interleaved data block with configuration shown in FIG. 3, therefore each even codeword has two defect data (such as E(0, 1) and E(215,1)), and each odd codeword has one defect data (such as E(216, 0)) in FIG. 4, where each codeword is defined as one column of data shown in FIG. 4 and has 216 main data and 32 parity data. In this embodiment, the process grouping the data block in FIG. 4 can be seen as a remapping process.

The even and odd codeword remapper 210 is utilized for remapping the quality-check signal to generate information of the even and odd codeword groups. The information of each codeword group includes an amount of data of any codeword in a corresponding codeword group that may induce decoding errors. Then, the counters 222 and 224 respectively records amounts of data of any codeword in the even or odd codeword groups that may induce decoding errors. In this embodiment, the counter 222 records a counter value “2” (because each even codeword has two defect data) and the counter 224 records a counter value “1” (because each odd codeword has one defect data).

Then, the comparing module 232 respectively compares the counter values stored in the counters 222 and 224 with a predetermined value to generate a defect judgment result, where the predetermined value can be a maximum defect data that is allowed in a codeword. If one of the counter values stored in the counters 222 and 224 is greater than the predetermined value, the defect judgment result generated from the comparing module 232 is at a first state, and the apparatus 100 stops encoding the interleaved data block, stops generating the encoded data and stops writing the encoded data into the blu-ray disc, therefore the verification unit 130 starts verifying the encoded data that have been written into the blu-ray disc. If both the counter values stored in the counters 222 and 224 are not greater than the predetermined value, the defect judgment result generated from the comparing module 232 is at a second state, the apparatus 100 continues encoding the interleaved data block and writing the encoded data into the blu-ray disc.

It is noted that the predetermined value can be set before the data writing procedure, and the predetermined value is fixed during the data writing procedure. However, the predetermined value also can be set to be adjustable during the writing procedure. For example, the predetermined value can be adjusted according to the writing speed, or according to types of disk indicated by the information stored in lead-in area of the disc.

In addition, the check point controller 234 is utilized for controlling a timing of the comparing module 232 comparing the counter values with the predetermined value, the timing can be set when encounters a boundary of a data block, every end point or start point of a fixed time. In addition, the timing can also be set when encounters a defect falling edge such as a timing after the data E(0,303) and the data E(216,302) shown in FIG. 3.

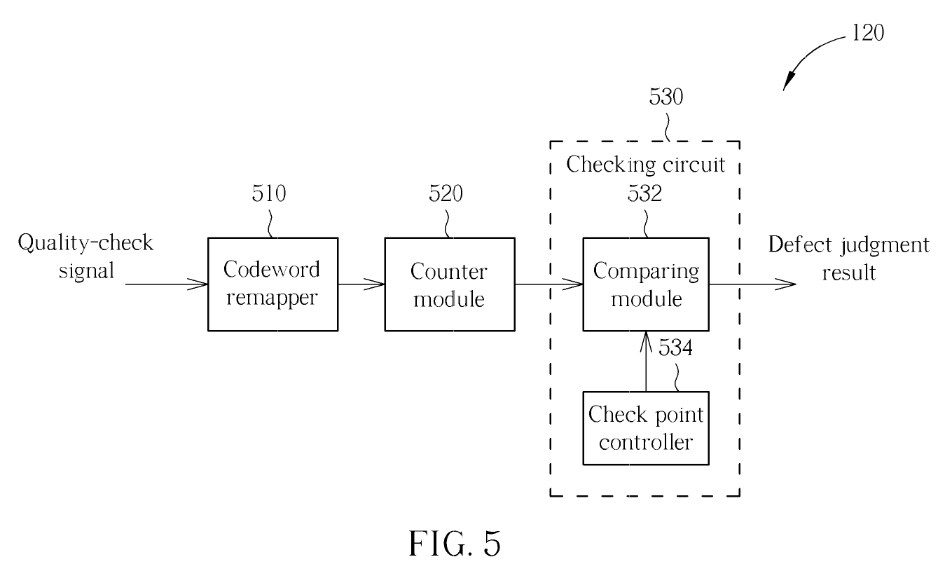

Please refer to FIG. 5. FIG. 5 is a diagram illustrating a block diagram according to a second embodiment of the defect judgment unit 120 shown in FIG. 1. As shown in FIG. 5, the defect judgment unit 120 includes a codeword remapper 510, a counter module 520 and a checking circuit 530, wherein the checking circuit 530 includes a comparing module 532 and a checking point controller 534. The detailed operations of the defectjudgment unit 120 shown in FIG. 5 are described as follows by taking a blu-ray disc as an example of the storage medium.

The codeword remapper 510 is utilized for remapping the quality-check signal to generate information of each codeword. The information of each codeword includes an amount of data of the codeword that may induce decoding errors. For example, the codeword remapper 510 remaps the data block in FIG. 4 to be 304 columns (not shown), thus, in this embodiment, the counter module 520 is configured with 304 counters, and the counters respectively record amounts of data of the codewords that may induce decoding errors in each column. Therefore, each counter records a counter value that indicates an amount of data of its corresponding codeword that may induce the decoding errors.

Then, the comparing module 532 compares the counter values stored in the counters with a predetermined value to generate a defect judgment result; in some embodiments, the predetermined value can be a maximum defect data that is allowed in a codeword. If one of the counter values stored in the counters is greater than the predetermined value, the defect judgment result generated from the comparing module 532 is at a first state, and the apparatus 100 stops encoding the interleaved data block, stops generating the encoded data and stops writing the encoded data into the blu-ray disc, therefore the verification unit 130 starts verifying the encoded data that have been written into the blu-ray disc. If all the counter values stored in the counter module are not greater than the predetermined value, the defectjudgment result generated from the comparing module 532 is at a second state, and the apparatus 100 continues encoding the interleaved data block and writing the encoded data into the blu-ray disc.

It is noted that the predetermined value can be set before the data writing procedure, and the predetermined value is fixed during the data writing procedure. However, the predetermined value also can be set to be adjustable during the writing procedure. For example, the predetermined value can be adjusted according to the writing speed, or according to types of disk indicated by the information stored in lead-in area of the disc.

In addition, the check point controller 534 is utilized for controlling a timing of the comparing module comparing the counter values with the predetermined value, and the timing can be set when encounters a boundary of a data block, every end point or start point of a fixed time, or a defect falling edge such as the timing after the data E(0,303) and the data E(216, 302) shown in FIG. 3.

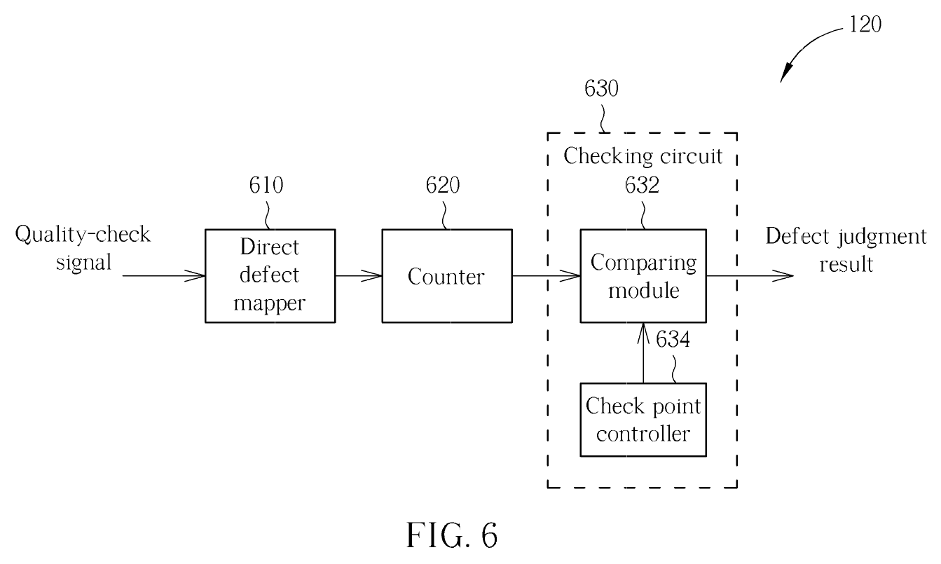

Please refer to FIG. 6. FIG. 6 is a diagram illustrating a block diagram according to a third embodiment of the defect judgment unit 120 shown in FIG. 1. As shown in FIG. 6, the defect judgment unit 120 includes a direct defect mapper 610, a counter 620 and a checking circuit 630, wherein the checking circuit 630 includes a comparing module 632 and a checking point controller 634. The detailed operations of the defect judgment unit 120 shown in FIG. 6 are described as follows by taking a blu-ray disc as an example of the storage medium and together with FIG. 3 and FIG. 4.

The direct defect mapper 610 is utilized for directly mapping the quality-check signal to generate information about a number of lines of data that may induce the decoding errors, it means that there is no remapping procedure (such as the grouping procedure shown in FIG. 4) in this embodiment of FIG. 6. Therefore, the counter 620 records the number of lines of data that may induce the decoding errors. In this embodiment, because there are three lines of data may induce decoding error in FIG. 3, a counter value stored in the counter 620 is “3”.

Then, the comparing module 632 compares the counter value stored in the counter 620 with a predetermined value to generate a defect judgment result, where the predetermined value can be a maximum defect data that is allowed in a codeword. If the counter value stored in the counter 620 is greater than the predetermined value, the defect judgment result generated from the comparing module 632 is at a first state, and the apparatus 100 stops encoding the interleaved data block, stops generating the encoded data and stops writing the encoded data into the blu-ray disc, therefore the verification unit 130 starts verifying the encoded data that have been written into the blu-ray disc; if the counter value stored in the counter 620 is not greater than the predetermined value, the defect judgment result generated from the comparing module 632 is at a second state, and the apparatus 100 continues encoding the interleaved data block and writing the encoded data into the blu-ray disc.

It is noted that the predetermined value can be set before the data writing procedure, and the predetermined value is fixed during the data writing procedure. However, the predetermined value also can be set to be adjustable during the writing procedure. For example, the predetermined value can be adjusted according to the writing speed, or according to types of disk indicated by the information stored in lead-in area of the disc.

In addition, the check point controller 634 is utilized for controlling a timing of the comparing module comparing the counter value with the predetermined value, and the timing can be set when encounters a boundary of a data block, every end point or start point of a fixed time, or a defect falling edge such as the timing after the data E(0,303) and the data E(216, 302) shown in FIG. 3.

In addition, in another embodiment of the present invention, the check point controller 634 can be removed from the defect judgment unit 120 shown in FIG. 6, and the predetermined value can be set to be zero, it means that the verification unit 130 starts verifying the encoded data whenever the defect is detected. That is, when any defect data is exit (counter value of the counter 620 is greater than zero), the apparatus 100 stops writing the encoded data into the blu-ray disc and the verification unit 130 starts verifying the encoded data that have been written into the blu-ray disc. This alternative design falls in the scope of the present invention.

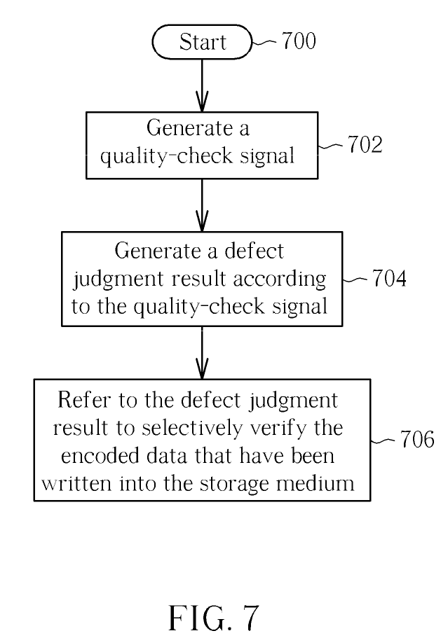

Please refer to FIG. 7. FIG. 7 is a simplified flowchart of writing encoded data into a storage medium according to one embodiment of the present invention. It is noted, provided the result is substantially the same, the steps are not limited to be executed according to the exact order shown in FIG. 7. Referring to the flowchart shown in FIG. 4, the operations of writing the encoded data into the storage medium are as follows:

Step 700: start.

Step 702: generate a quality-check signal.

Step 704: generate a defect judgment result according to the quality-check signal.

Step 706: refer to the defect judgment result to selectively verify the encoded data that have been written into the storage medium.

It is noted that, in the present invention, the verification unit refers to the defect judgment result to selectively verify the encoded data that have been written into the storage medium. However, if the storage medium has a bad quality, applying the present invention to encode and write data into the storage medium may be inefficient. Therefore, before data are encoded and written into the storage medium, the storage medium is checked according to one of the following methods to determine a write status of the storage medium. Then, it is determined if the method for encoding and writing data into the storage medium of the present invention is applied or not.

Taking an optical disc as the storage medium, a first method to determine the write status of the optical disc includes: writing test data onto several area of the optical disc, and checking a focus condition, reflection, or servo controllability to determine the write status of the optical disc. A second method includes: recording a number of re-written times of the optical disc on a reserved area, and the write status can be determined by obtaining the information from this reserved area. In addition, when it is a recordable disc (only support write once), the write status of the optical disc is naturally suitable for applying the present invention to encode and write data into the optical disc.

If the write status of the optical disc is unsuitable for applying the method of the present invention to encode and write data into the optical disc, a related method that each data block that has been written into the optical disc needs to be verified can be applied.

Briefly summarizing the present invention, an apparatus for writing encoded data into a storage medium includes a quality-check signal generator, a defect judgment unit and a verification unit. The quality-check signal generator is utilized for generating a quality-check signal; the defect judgment unit is utilized for generating a defectjudgment result according to the quality-check signal; and the verification unit is utilized for referring to the defect judgment result to selectively verify the encoded data that have been written into the storage medium. Therefore, not all the data written into the storage disc need to be verified, and the efficiency of writing the encoded data into the storage medium is increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for writing encoded data into a storage medium, comprising:
a quality-check signal generator, for generating a quality-check signal;
a defect judgment unit, coupled to the quality-check signal generator, for generating a defect judgment result according to the quality-check signal; and
a verification unit, coupled to the defect judgment unit, for referring to the defect judgment result to selectively verify the encoded data that have been written into the storage medium.

2. The apparatus of claim 1, wherein the quality-check signal generator detects a quality of the storage medium to generate the quality-check signal.

3. The apparatus of claim 1, wherein when the defect judgment result is at a first state, the apparatus stops writing the encoded data into the storage medium, and the verification unit starts verifying the encoded data that have been written into the storage medium; and when the defect judgment result is at a second state different from the first state, the apparatus continues writing the encoded data into the storage medium.

4. The apparatus of claim 1, wherein the encoded data is derived from a data block, the data block comprises a plurality of lines of data, information transmitted via the quality-check signal indicates the data with a decoding error, and the defect judgment unit comprises:
a remapper, for remapping the quality-check signal to generate information of a plurality of codeword groups according to a de-interleaving operation performed upon the data block to generate a de-interleaved data block, wherein the de-interleaved data block comprises a plurality of codeword groups each comprising a plurality of codewords, and the information of each codeword group includes an amount of data of any codeword in a corresponding codeword group with decoding errors;
a plurality of counters, wherein each of the counters records a counter value indicating an amount of data of any codeword in a corresponding codeword group with decoding errors; and
a checking circuit, for generating the defect judgment result according to counter values respectively generated from the counters.

5. The apparatus of claim 4, wherein the checking circuit comprises:
a comparing module, coupled to the counters, for comparing the counter values with a predetermined value to generate the defect judgment result.

6. The apparatus of claim 5, wherein the checking circuit further comprises:
a check point controller, coupled to the comparing module, for controlling a timing of the comparing module comparing the counter values with the predetermined value.

7. The apparatus of claim 6, wherein the timing is at a boundary of the data block.

8. The apparatus of claim 1, wherein the encoded data is derived from a data block, the data block comprises a plurality of lines of data, information transmitted via the quality-check signal indicates the data with a decoding error, and the defect judgment unit comprises:
a counter, for counting a number of lines of data with decoding errors to generate a counter value; and
a checking circuit, coupled to the counter, for generating the defect judgment result according to the counter value.

9. The apparatus of claim 8, wherein the checking circuit comprises:
a comparing module, coupled to the counter, for comparing the counter value with a predetermined value to generate the defect judgment result.

10. The apparatus of claim 9, wherein the checking circuit further comprises:
a check point controller, coupled to the comparing module, for controlling a timing of the comparing module comparing the counter value with the predetermined value.

11. The apparatus of claim 10, wherein the timing is at a boundary of the data block.

12. A method for writing encoded data into a storage medium, comprising:
generating a quality-check signal;
generating a defect judgment result according to the quality-check signal; and
referring to the defectjudgment result to selectively verify the encoded data that have been written into the storage medium.

13. The method of claim 11, wherein the step of generating the quality-check signal comprises:
detecting a quality of the storage medium to generate the quality-check signal

14. The method of claim 12, wherein when the defect judgment result is at a first state, stopping writing the encoded data into the storage medium, and starting verifying the encoded data that have been written into the storage medium; and when the defect judgment result is at a second state different from the first state, continuing writing the encoded data into the storage medium.

15. The method of claim 12, wherein the encoded data is derived from a data block, the data block comprises a plurality of lines of data, information transmitted via the quality-check signal indicates the data with a decoding error, and the step of generating the defect judgment result according to the quality-check signal comprises:
remapping the quality-check signal to generate information of a plurality of codeword groups according to a de-interleaving operation performed upon the data block to generate a de-interleaved data block, wherein the de-interleaved data block comprises a plurality of codeword groups each comprising a plurality of codewords, and the information of each codeword group includes an amount of data of any codeword in a corresponding codeword group with decoding errors;
recording a counter value indicating an amount of data of any codeword in the each of the codeword group with decoding errors; and
generating the defect judgment result according to counter values.

16. The method of claim 15, wherein the step of generating the defectjudgment result according to the counter values comprises:
comparing the counter values with a predetermined value to generate the defect judgment result.

17. The method of claim 16, wherein the step of generating the defect judgment result according to the counter values further comprises:
controlling a timing of comparing the counter values with the predetermined value.

18. The method of claim 17, wherein the timing is at a boundary of the data block.

19. The method of claim 12, wherein the encoded data is derived from a data block, the data block comprises a plurality of lines of data, information transmitted via the quality-check signal indicates the data with a decoding error, and the step of generating the defect judgment result according to the quality-check signal comprises:
counting a number of lines of data with decoding errors to generate a counter value; and
generating the defect judgment result according to the counter value.

20. The method of claim 19, wherein the step of generating the defect judgment result according to counter value comprises:
comparing the counter value with a predetermined value to generate the defect judgment result.

21. The method of claim 20, wherein the step of generating the defectjudgment result according to counter value further comprises:
controlling a timing of comparing the counter value with the predetermined value.

22. The method of claim 21, wherein the timing is at a boundary of the data block.
